(19) United States
(12) Patent Application Publication
(10) Pub. No.: US 2007/0215602 A1
(43) Pub. Date: Sep. 20, 2007

(54) HEATING AND COOLING MODULE

(75) Inventors: Masuhiro Natsuhara, Itami-shi (JP); Tomoyuki Awazu, Itami-shi (JP); Hirohiko Nakata, Itami-shi (JP); Akira Mikumo, Itami-shi (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/684,895

(22) Filed: Mar. 12, 2007

(30) Foreign Application Priority Data
Mar. 17, 2006 (JP) 2006-073648

(51) Int. Cl. H05B 3/10

(52) U.S. Cl. 219/552

(57) ABSTRACT

A heating and cooling module wherein the calorific value can be increased in a heater for mounting and heating a semiconductor chip, and the heating and cooling module is not damaged when the semiconductor chip is rapidly heated and cooled. The heating and cooling module of the includes a ceramic heater for mounting and heating a treated object, a cooling mechanism for cooling the ceramic heater, and a holder between the ceramic heater and the cooling mechanism, wherein the ceramic heater is an aluminum nitride heater having one or more internally disposed heating element layers. An intermediate layer is preferably inserted between the ceramic heater and the holder. An intermediate layer is also preferably inserted between the holder and the cooling mechanism.

### TECHNICAL FIELD

The present invention relates to an apparatus for heating, cooling, and inspecting a treated object; and particularly relates to a heating and cooling module used in a tester for inspecting a semiconductor chip.

### BACKGROUND ART

Various apparatuses for heating and cooling semiconductor chips have been proposed in the past. Particularly, as semiconductor chips come to have greater capacity, higher functionality, and higher speeds in recent years, there is a tendency for the calorific value during operation to become increasingly larger. There is also a demand to improve throughput, and inspection apparatuses and testers for semiconductor chips must heat the semiconductor chip in the shortest possible amount of time, and must rapidly cool the chip after an electrical experiment is conducted. For example, various structures for burn-in devices and the like have been proposed, as is disclosed in Patent Document 1.

However, when a large amount of electricity is applied to the heating element of a heating and cooling apparatus in order to rapidly heat a semiconductor chip, problems are encountered with the heating and cooling device being damaged. There have also been structural restrictions between the cooling mechanism and the semiconductor chip when rapid cooling is attempted, and there have been limits on the cooling rate as well.

Patent Document 1 Japanese Laid-open Patent Application Publication No. 2005-265665

### SUMMARY OF THE INVENTION

### Problems the Invention is Intended to Solve

The present invention was designed in order to resolve these problems. Specifically, an object of the present invention is to provide a heating and cooling module wherein the calorific value can be increased in a heater for mounting and heating a semiconductor chip, and the heating and cooling module is not damaged when the semiconductor chip is rapidly heated and cooled.

### MEANS FOR SOLVING THESE PROBLEMS

The heating and cooling module of the present invention is a heating and cooling module comprising a ceramic heater for mounting and heating a treated object, a cooling mechanism for cooling the ceramic heater, and a holder between the ceramic heater and the cooling mechanism; and is characterized in that the ceramic heater is an aluminum nitride heater having one or more internally disposed heating element layers. Rapid increases in temperature are made possible by forming one or more heating element layers in the interior of the aluminum nitride.

There is preferably an intermediate layer between the ceramic heater and the holder. There is also preferably an intermediate layer between the holder and the cooling mechanism. These soft intermediate layers make rapid cooling possible.

Having two or more heating element layers inside the aluminum nitride heater makes it possible to apply more power to the heating element layers, which makes faster increases in temperature possible.

The thermal conductivity of the holder is preferably 100 W/mK or greater. Rapid cooling is made possible by using a material having a thermal conductivity of 100 W/mK or greater for the holder.

The aluminum nitride heater, the holder, and the cooling mechanism as described above are preferably fixed in place mechanically. Mechanically fixing these members in place makes it possible to prevent damage to the heater during heating and cooling resulting from the difference in thermal expansion coefficients.

According to the present invention, it is possible to provide a heating and cooling module that is suitable for a semiconductor chip tester having excellent temperature increase and reduction characteristics.

### BRIEF DESCRIPTION OF THE DRAWINGS

FIG. 1 shows an example of a cross-sectional structure of the heating and cooling module of the present invention;

FIG. 2 shows another example of a cross-sectional structure of the heating and cooling module of the present invention; and

FIG. 3 shows an example of a cross-sectional structure of the cooling mechanism of the present invention.

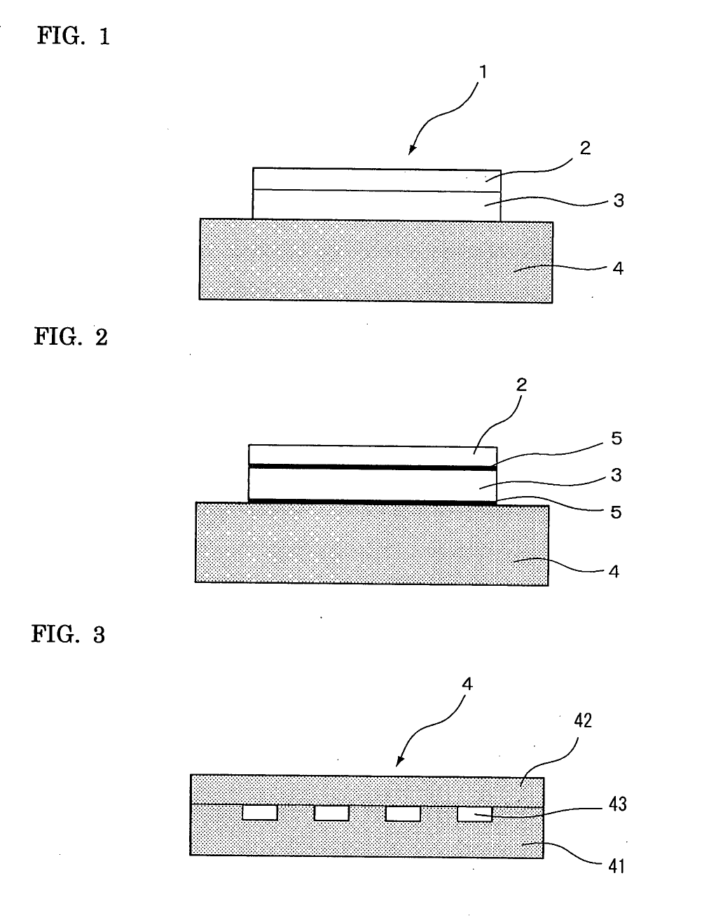

### KEY

1 heating and cooling module
2 AlN heater
3 holder
4 cooling mechanism
5 intermediate layer

### BEST MODE FOR CARRYING OUT THE INVENTION

The heating and cooling module 1 of the present invention has a holder 3 on the bottom surface of an aluminum nitride heater 2, and furthermore has a cooling mechanism 4 on the bottom of the holder. A semiconductor chip is mounted and heated on the aluminum nitride heater of the heating and cooling module having this configuration. After the semiconductor chip is heated to a specific temperature and a specific inspection is performed, the heater output is reduced or turned off, whereby the heater can be cooled by the cooling mechanism through the holder, and the semiconductor chip can also be cooled.

In semiconductor chip inspection, which is the field of the present invention, the temperature of the heater is repeatedly increased and decreased in a short amount of time, creating thermal stress. Therefore, if the heater is formed from alumina or another ceramic having low thermal conductivity, the ceramic is sometimes cracked and damaged due to the effects of thermal shock or the like. Aluminum nitride generally has a thermal conductivity of 70 W/mK or greater, and is preferred over alumina or the like because of considerations related to resistance to thermal shock.

The interior of the aluminum nitride substrate preferably has one or more heating element layer for heating the semiconductor chip. The heating element can be formed on the surface of the aluminum nitride substrate, but is preferably embedded in the interior because there is no need for the heating element to be insulated from the holder or the cooling module when the embedded layout is adopted. Multiple heating element layers are preferably formed as the aluminum nitride heater.

For example, with two heating element layers, the heating element circuit can be supplied with twice the power of one layer. Therefore, the temperature can be increased more quickly, and throughput can be improved. In other words, more heating element layers are preferred because a greater amount of power can be supplied to the aluminum nitride heater. Specifically, the amount of power that can be supplied is normally several dozen watts to about 200 W, but with the structure of the present invention, a maximum of about 1 kW can be supplied.

The size of the heater normally used to heat the semiconductor chip is, e.g., about 20 to 25 mm. Forming multiple heating element layers as described above makes it possible to easily adapt to the formation of circuitry for supplying such a large amount of power to a heater of this size.

The thickness of the aluminum nitride heater used in the present invention is preferably 0.3 mm or more. The thickness is preferably not less than this because mechanical shock may cause damage. The thickness is also preferably 5 mm or less. The thickness is preferably not greater than this because the heat capacity of the aluminum nitride heater increases, and more time is therefore required for cooling. The most preferred thickness for the aluminum nitride heater is 0.5 to 2 mm. The thickness is preferably in this range because the cooling rate is high due to the comparatively low heat capacity, and mechanical shock does not cause damage.

The heating and cooling module of the present invention has a holder on the bottom surface of the above-described aluminum nitride heater, and furthermore has a cooling mechanism on the bottom of the holder. A semiconductor chip is mounted and heated on the aluminum nitride heater of the heating and cooling module thus configured. After the semiconductor chip is heated to a specific temperature and a specific inspection is performed, the heater output is reduced or turned off, whereby the heater can be cooled by the cooling mechanism through the holder, and the semiconductor chip can be cooled. The semiconductor chip can thereby be heated and cooled.

In the process of this type of heating and cooling, heat is exchanged in conjunction with heating and cooling between the aluminum nitride heater and the holder, and also between the holder and the cooling mechanism. Therefore, it is preferable that intermediate layers 5 having high thermal conductivity be inserted in the interfaces between these members, as shown in FIG. 2. The intermediate layers may be inserted between the aluminum nitride heater and the holder as well as between the holder and the cooling mechanism as shown in FIG. 2, or an intermediate layer may be inserted in only one of these positions.

These intermediate layers must be made of a soft material in order to be capable of firmly adhering to the aluminum nitride heater, the holder, and the cooling mechanism. Specifically, since the aluminum nitride heater, the holder, and the cooling mechanism are all made of hard materials, gaps will inevitably form between these members in cases in which they are in direct contact with each other. Air fills up these gaps, which is a considerable hindrance to heat transfer. Therefore, in order to cover these gaps, soft material is inserted so as to conform to the shapes of the superimposed surfaces, whereby irregularities are eliminated from heat transfer, and heat can be transferred uniformly and smoothly.

No particular problems are encountered as long as the soft material is heat resistant within the range of service temperatures, and possible selections include, e.g., a heat resistant resin, a soft metal, graphite, and the like. Possible examples of a heat resistant resin include an epoxy resin, a polyimide resin, a silicon resin, and a phenol resin. These resins can be used because the aluminum nitride heater used in the present invention has a maximum temperature of about 300° C. Since higher thermal conductivity is preferred for the intermediate layers, the thermal conductivity can be increased by adding alumina, silica, AlN, BN, or a metal powder to these resins.

Possible examples of the soft metal include indium, copper, aluminum, and other such metals and alloys. Graphite and other such carbon materials, and foamed metals and the like can also be used. Since these materials are all deformable soft materials, inserting these materials between the other members enables heat to be transferred smoothly.

The thermal conductivity of the holder located between the aluminum nitride heater and the cooling mechanism is preferably 100 W/mK or greater. The holder has the role of supporting the aluminum nitride heater as well as transferring the temperature of the cooling mechanism to the aluminum nitride heater to rapidly take heat from the aluminum nitride heater. Therefore, the holder preferably has high thermal conductivity, and 100 W/mK or more is particularly preferred. Possible examples of specific materials include copper and an alloy thereof, such as, e.g., Cu—W and Cu—Mo. Aluminum or an alloy thereof, or silver, gold, or the like can also be used. It is also possible to use aluminum nitride, silicon carbide, or another such ceramic; and Al—SiC, Si—SiC, Al—AlN, or another such complex. Since these materials are heated to high temperatures, a heat resistant film may be formed on the surface. Possible examples of a heat resistant film include nickel, silver, gold, platinum, and the like, and these films can be formed by sputtering, vapor deposition, and other such techniques; or plating and other such techniques.

The cooling mechanism is not particularly limited, and can have a structure in which channels 43 for a coolant are formed in a metal plate 41, and a metal plate 42 is used as a cover, as shown in FIG. 3, for example. The material of the cooling mechanism is not particularly limited, but a material having high thermal conductivity is preferred. For example, the same material as the holder can be used. Stainless steel or another such metal material can also be used.

The method for forming the channels is not particularly limited. Metal pipes can be attached to the opposite side of the plate on which the holder is mounted, and a coolant can be passed through the interior of these pipes. The cross-sectional shapes of the metal pipes are not particularly limited, and circles, squares or various other shapes can be used. Furthermore, since the coolant-transporting pipes must firmly adhere to the plate, adhesion between the pipes and the plate can be ensured by screwing the metal pipes onto the plate, or providing the plate with countersinks whose shape is substantially the same as the cross-sectional shape of the metal pipes.

Furthermore, effective cooling is made possible by inserting a soft material such as is described above between the metal pipes and the plate.

The configuration may have one holder and one aluminum nitride heater mounted on one cooling mechanism, or may also have, e.g., four, eight, sixteen, or more holders and aluminum nitride heaters mounted on one cooling mechanism.

The coolant that flows through the metal pipes is not particularly limited, and water, air, Fluorinert, and other such compounds, or the like can be used according to the service temperature.

Brazing or another such method can be used to connect the aluminum nitride heater, the holder, and the cooling mechanism, but screwing or another such mechanical method is preferably used. The reason for this is because there is a large difference in the amount of temperature-induced thermal expansion between cases in which the temperature difference between the aluminum nitride heater and the cooling mechanism is large and cases in which the temperature difference is small. Therefore, there is likely to be thermal stress between the cooling mechanism and the aluminum nitride heater, curves may form, and in worst cases the aluminum nitride heater may be damaged. In cases in which screws are used, through-holes larger in diameter than the screws are formed in the holder and the aluminum nitride heater, and the screws are inserted into the holes and can be screwed into a female thread formed in the cooling mechanism. Through-holes are formed with larger diameters than the screws in order to prevent damage and deformation even if the heater causes these members to increase in temperature and thermally expand. The material for the screws used herein is not particularly limited, and stainless steel, Kovar, or the like can be used.

As described above, in cases in which the heating and cooling module is used to inspect semiconductor chips, the temperature of the heater can be increased and reduced in short cycles, and it is therefore possible to provide an apparatus that has excellent through-put.

The raw powder of the aluminum nitride (AlN) in the aluminum nitride heater of the present invention preferably has a specific surface area of 2.0 to 5.0 m²/g. If the specific surface area is 2.0 m²/g, the aluminum nitride is less sinterable. If the specific surface area exceeds 5.0 m²/g, the powder is difficult to handle because of severe clumping. Furthermore, the oxygen content of the raw powder is preferably 2 wt % or less. If the oxygen content exceeds 2 wt %, the thermal conductivity of the sintered product is reduced. Also, the content of metal impurities other than aluminum in the raw powder is preferably 2000 ppm. If the metal impurity content exceeds this range, the thermal conductivity of the sintered product is reduced. Particularly, Si and other IV group elements, and Fe and other iron group elements are metal impurities that have a strong effect in reducing the thermal conductivity of the sintered product, and the content of each of these impurities is therefore preferably 500 ppm or less.

AlN is resistant to sintering, and it is therefore preferable to add a sintering aid to the AlN raw powder. The added sintering aid is preferably a rare-earth element compound. The thermal conductivity of the aluminum nitride sintered product can be improved because rare-earth element compounds react with the aluminum oxide or aluminum oxynitride in the surfaces of the aluminum nitride powder grains during sintering. This promotes densification of the aluminum nitride, and also acts to remove oxygen, which is the cause of reduced thermal conductivity in the aluminum nitride sintered product.

The rare-earth element compound is preferably an yttrium compound, which has a particularly remarkable oxygen removal effect. The added amount is preferably 0.01 to 5 wt %. If the added amount is less than 0.01 wt %, it is difficult to obtain a dense sintered product, and the thermal conductivity of the sintered product is reduced. If the amount exceeds 5 wt %, the sintering aid is present along the grain boundaries of the aluminum nitride sintered product. Therefore, in cases in which the aluminum nitride sintered product is used in a corrosive atmosphere, the sintering aid in the grain boundaries is etched, resulting in shedding or particle formation. Furthermore, the added amount of the sintering aid is preferably 1 wt % or less. If the amount is 1 wt % or less, corrosion resistance is improved because the sintering aid is not present in the three major points of the grain boundaries.

An oxide, a nitride, a fluoride, a stearic acid compound, or the like can be used as the rare-earth element compound. An oxide is the most preferred of these because oxides are inexpensive and easily procured. A stearic acid compound is also particularly preferable because such a compound has high affinity for organic solvents and easily mixes in cases in which the aluminum nitride raw power, the sintering aid, and other components are mixed with an organic solvent.

Next, specific amounts of a solvent, a binder, and an optional dispersing agent or deflocculant are added and mixed with the aluminum nitride raw powder and the sintering aid powder. Ball mill mixing, mixing with the aid of ultrasonic waves, and other such mixing methods can be used. Raw slurry can be obtained by mixing.

The resulting slurry can be molded and sintered to obtain an aluminum nitride sintered product. This can be accomplished by means of two methods, which are co-firing and post-metallizing.

Post-metallizing will first be described. Granules are created from the slurry by spray drying or another such method. The granules are introduced into a specific mold and are press-molded. At this time, the pressure of the press is preferably 9.8 MPa or greater. If the pressure is less than 9.8 MPa, the molded product often has insufficient strength and is likely to be damaged during handling.

The density of the molded product varies depending on the binder content and the added amount of the sintering aid, but is preferably 1.5 g/cm³ or greater. If the density is less than 1.5 g/cm³, sintering does not progress readily because the distance between raw powder grains is relatively large. Also, the density of the molded product is preferably 2.5 g/cm³ or less. If the density exceeds 2.5 g/cm³, it is difficult to sufficiently remove the binder from the molded product in the next step of degreasing. Therefore, it is difficult to obtain a dense sintered product as previously described.

Next, the molded product is heated in a nonoxidizing atmosphere and is degreased. If the molded product is degreased in normal atmospheric conditions or another oxidizing atmosphere, the thermal conductivity of the sintered product is reduced because the surface of the AlN powder is oxidized. Nitrogen or argon is preferred as the nonoxidizing ambient gas. The heating temperature for the degreasing treatment is preferably 500° C. or greater and 1000° C. or less. At a temperature less than 500° C., an excess amount of carbon remains in the degreased layered product because the binder cannot be sufficiently removed, and sintering in the following sintering step is therefore inhibited. At a temperature exceeding 1000° C., little carbon remains, and therefore the capacity for removing oxygen from the oxidized coating in the AlN powder surface is reduced, as is the thermal conductivity of the sintered product.

The carbon content remaining in the degreased molded product is preferably 1.0 wt % or less. If the remaining carbon content exceeds 1.0 wt %, sintering is inhibited and a dense sintered product therefore cannot be obtained.

Next, sintering is performed. Sintering is performed at a temperature of 1700 to 2000° C. in a nonoxidizing atmosphere of nitrogen, argon, or the like. At this time, the moisture in the nitrogen or other ambient gas used herein preferably has a dew point of −30° C. or less. Moisture with a higher dew point than this may reduce the thermal conductivity because the AlN reacts with the moisture in the ambient gas during sintering to form oxynitride. Also, the oxygen content in the ambient gas is preferably 0.001 vol % or less. If the oxygen content is high, the surface of the AlN is oxidized, which may reduce the thermal conductivity.

Furthermore, the jig used during sintering is preferably a molded boron nitride (BN) product. Since this BN molded product is sufficiently heat resistant against the sintering temperature and has solid lubrication on the surface, friction can be reduced between the jig and the layered product when the layered product shrinks during sintering, and it is therefore possible to obtain a strain-free sintered product.

The obtained sintered product is machined as necessary. In cases in which an electroconductive paste in the next step is subjected to screen printing, the surface roughness Ra of the sintered product is preferably 5 μm or less. If the surface roughness exceeds 5 μm, pattern blurring, pinholes, and other such defects are likely to occur when circuits are formed by screen printing. The surface roughness Ra is even more preferably 1 μm or less.

When the surface roughness is polished, it is natural to use screen printing on both surfaces of the sintered product, but in cases in which only one surface is subjected to screen printing, both the screen printed surface and the opposite surface may be polished. In cases in which only the screen printed surface is polished, the sintered product is supported during screen printing by the surface that is not polished. At this time, the sintered product is not stably fixed since the unpolished surface contains protuberances and impurities. This is the reason that the circuit pattern cannot be adequately drawn by screen printing.

Also at this time, the parallelism of the machined surfaces is preferably 0.5 mm or less. If the parallelism exceeds 0.5 mm, the nonuniformities in the thickness of the electroconductive paste may become severe during screen printing. It is particularly preferred that the parallelism be 0.1 mm or less. Furthermore, the flatness of the screen printed surfaces is preferably 0.5 mm or less. Nonuniformities in the thickness of the electroconductive paste may also become severe in cases in which the flatness exceeds 0.5 mm. It is particularly preferred that the flatness be 0.1 mm or less.

The polished sintered product is coated with an electroconductive paste by screen printing, and electric circuitry is formed. The electroconductive paste can be obtained by mixing an oxide powder, a binder, and a solvent as necessary with a metal powder. The metal powder is preferably tungsten, molybdenum, or tantalum because their thermal expansion coefficients match that of the ceramic.

An oxide powder can be added to increase the bonding strength with AlN. The oxide powder is preferably a group IIa element or group IIIa element oxide, Al₂O₃, SiO₂, or the like. Yttrium oxide is particularly preferred because it is very easily wetted by AlN. The added content of these oxides is preferably 0.1 to 30 wt %. In cases in which the added content is less than 0.1 wt %, bonding strength is reduced between the AlN and the metal layer that forms the electric circuitry. If the added content exceeds 30 wt %, the metal layer that forms the electric circuitry has a higher electrical resistance.

The thickness of the electroconductive paste preferably ranges from 5 μm or greater to 100 μm or less after drying. In cases in which the thickness is less than 5 μm, the electrical resistance is too high, and the bonding strength is reduced. Bonding strength is also reduced in cases in which the thickness exceeds 100 μm.

In cases in which the formed circuit pattern is designed for heater circuitry (heat generator circuitry), the intervals in the pattern are preferably 0.1 mm or greater. If the intervals are less than 0.1 mm, a leakage current arises depending on the applied voltage and temperature when an electric current flows to the heat-generating body, and a short circuit occurs. In particular, the pattern intervals are preferably 1 mm or greater, and even more preferably 2 mm or greater, in cases in which the circuit pattern is used at a temperature of 200° C. or greater. In the present invention, multiple heat-generating layers can be formed. Therefore, multiple substrates are prepared using the same method as described above, and heat generators are formed on each substrate.

Next, the electroconductive paste is degreased and sintered. The degreasing is performed in a nonoxidizing atmosphere of nitrogen, argon, or the like. The degreasing temperature is preferably 500° C. or greater. If the temperature is less than 500° C., the binder is not sufficiently removed from the electroconductive paste, carbon remains in the metal layer, metal carbides form during sintering, and the electrical resistance of the metal layer increases.

It is preferred that sintering be performed in a nonoxidizing atmosphere of nitrogen, argon, or the like at a temperature of 1500° C. or greater. At a temperature less than 1500° C., the grains of the metal powder in the electroconductive paste do not grow, and the electrical resistance of the sintered metal layer is therefore too high. This sintering temperature should not exceed the sintering temperature of the ceramic. If the electroconductive paste is sintered at a temperature exceeding the sintering temperature of the ceramic, the sintering aid and other components in the ceramic begin to be volatilized, and grain growth is facilitated in the metal powder in the electroconductive paste, reducing the bonding strength between the ceramic and the metal layer.

Next, an insulating coating can be formed on the metal layer in order to ensure that the formed metal layer is insulated. The material of the insulating coating is preferably the same material as the ceramic on which the metal layer is formed. If the material of the insulating coating is markedly different from the ceramic, problems are encountered with post-sinter warping because of the difference in thermal expansion coefficients. For example, in the case of AlN, a specific amount of a group IIa element or group IIIa element oxide or carbonated compound is added and mixed as a sintering aid with the AlN powder. A binder or solvent is then added to form a paste, and the metal layer can be coated with the paste by screen printing.

At this time, the added amount of the sintering aid is preferably 0.01 wt % or greater. If the added amount is less than 0.01 wt %, the insulating coating is not densified, and it is difficult to ensure that the metal layer is insulated. The sintering aid content also preferably does not exceed 20 wt %. If the content exceeds 20 wt %, the excess sintering aid permeates into the metal layer, and the electrical resistance of the metal layer sometimes changes. The coating thickness is not particularly limited, but is preferably 5 μm or greater. This is because it is difficult to ensure insulation if the thickness is less than 5 μm.

Such ceramic substrates can then be stacked together. The stacking can be carried out using an adhesive. The adhesive is a paste formed by adding a group IIa element compound or a group IIIa element compound and a binder or adhesive to an aluminum oxide powder or an aluminum nitride powder, and this paste is used to coat the bonding surface by means of screen printing or another such method. The thickness of the applied adhesive is not particularly limited, but is preferably 5 μm or greater. If the thickness is less than 5 μm, pinholes, bonding irregularities, and other such bonding defects are likely to form in the bonding layer.

The ceramic substrate coated with the adhesive is degreased in a nonoxidizing atmosphere at a temperature of 500° C. or greater. The stacked ceramic substrates are then superposed on each other, subjected to a specific load, and then heated in a nonoxidizing atmosphere to bond the ceramic substrates together. The load is preferably 5 kPa or greater. If the load is less than 5 kPa, either sufficient bonding strength is not obtained, or bonding defects are likely.

The heating temperature for bonding is not particularly limited if the ceramic substrates can be sufficiently bonded together with the aid of the bonding layer, but the temperature is preferably 1500° C. or greater. If the temperature is less than 1500° C., it is difficult to obtain sufficient bonding strength, and bonding defects are likely to occur. It is preferable to use nitrogen, argon, or the like for the nonoxidizing atmosphere during degreasing and bonding. An aluminum nitride heater can be obtained in the manner described above.

Next, co-firing will be described. The previously described raw slurry is sheet molded by means of the doctor blade method. The sheet molding is not particularly limited, but the thickness of the sheet is preferably 3 mm or less after drying. If the thickness of the sheet exceeds 3 mm, the probability of the sheet cracking increases because the amount of drying shrinkage in the slurry is greater.

The metal layer, which constitutes electric circuitry having a specific shape, is formed on the sheet by applying an electroconductive paste by means of screen printing or another such method. The electroconductive paste can be the same as the electroconductive paste described in post-metallizing. In co-firing, no problems are encountered as long as an oxide powder is not added to the electroconductive paste.

Next, the sheet on which circuitry is formed and the sheet on which circuitry is not formed are stacked. Multiple sheets having circuitry formed thereon can be stacked in this manner. The sheets are stacked by being set in specific positions and superposed on each other. A solvent is applied between the sheets as necessary. The sheets are heated as necessary while they are superposed on each other. If the sheets are heated, the heating temperature is preferably 150° C. or less. If the heating temperature exceeds this temperature, the stacked sheets are markedly deformed. Pressure is applied to the superposed sheets to integrate them. The applied pressure is preferably within a range of 1 to 100 MPa. At a pressure less than 1 MPa, the sheets are not sufficiently integrated, and peeling may occur in the subsequent steps. If a pressure exceeding 100 MPa is applied, the amount of deformation in the sheets is too great.

This stack is degreased and sintered in the same manner as in the post-metallizing previously described. The temperatures for degreasing and sintering, the amount of carbon, and other such conditions are the same as in post-metallizing. When the electroconductive paste is printed on the sheets, heater circuitry is printed on one or more sheets, and the sheets are then stacked, whereby an aluminum nitride heater having one or more heat-generating circuits can be created.

The resulting aluminum nitride heater is machined as necessary. Normally, the required precision is often not achieved when the heater has been sintered. The machining precision is preferably such that the flatness of the treated object mounting surface is 0.1 mm or less, or even more preferably 0.05 mm or less. If the flatness exceeds 0.5 mm, gaps are likely to form between the treated object (semiconductor chip) and the aluminum nitride heater, the heat from the aluminum nitride heater is not uniformly transferred to the semiconductor chip, and the semiconductor chip is likely to have temperature irregularities.

The treated object mounting surface of the aluminum nitride heater preferably has a surface roughness Ra of 5 μm or less. If the roughness Ra exceeds 5 μm, the friction between the aluminum nitride heater and the semiconductor chip may cause much shedding of AlN. The surface roughness Ra is even more preferably 1 μm or less.

### Embodiment 1

5 parts by weight of yttrium oxide (Y₂O₃) were added to 95 parts by weight of aluminum nitride (AlN) powder, then an acrylic binder and an organic solvent were added, and the components were all mixed for 24 hours in a ball mill to form an AlN slurry. An AlN sheet was formed from this slurry by the doctor blade method. The aluminum nitride powder that was used had a mean grain size of 0.6 μm and a specific surface area of 3.4 m²/g.

For the resistance heating element, 0.5 wt % of Y₂O₃ was added to W powder having a mean grain size of 2.0 μm, and a binder and solvent were then added to create W paste. A pot mill and three rollers were used to mix the ingredients. A heater circuit pattern was formed on the AlN sheet by screen printing the W paste.

The AlN sheet on which the heater circuitry was printed and the sheet on which heater circuitry was not printed were stacked together and thermocompressed to create a sheet mold. This sheet mold was degreased at 800° C. in a nitrogen atmosphere and then sintered at 1850° C. in a nitrogen atmosphere to create a square aluminum nitride heater with sides 20 mm long. AlN heaters of the types shown in Table 1 were created by varying the number of stacked layers of AlN sheets on which heater circuitry was printed and AlN sheets on which heater circuitry was not printed.

TABLE 1

| No | Number of stacked heaters | Thickness (mm) |
|---|---|---|
| 1 | 1 | 0.5 |
| 2 | 2 | 1.5 |
| 3 | 3 | 2.0 |
| 4 | 3 | 5.0 |
| 5 | 3 | 8.0 |
| 6 | 1 | 0.3 |
| 7 | 1 | 0.25 |
| 8 | 5 | 3.0 |

The materials shown in Table 2 were prepared for the holder. The size of these members was 20×20×10 mm (thickness) in each case.

TABLE 2

| | | Thermal | |
|---|---|---|---|
| | | conductivity | |
| | Material | (W/mK) | Comments |
| A | Copper | 400 | surface plated |
| | | | with Ni |
| B | Aluminum | 200 | |
| C | Cu—W | 180 | surface plated |
| | | | with Ni |
| D | Si—SiC | 170 | |
| E | Stainless steel | 20 | |
| F | Silicon carbide | 180 | |
| G | Alumina | 30 | |
| H | Aluminum | 100 | |
| | nitride | | |

For the cooling mechanism, a square copper plate with sides 80 mm long and a thickness of 2 mm, and a square copper plate with sides 80 mm long and a thickness of 4 mm were prepared, and a coolant channel was formed by countersinking in the copper plate that was 4 mm thick. After the surfaces of these copper plates were covered with nickel plating, the copper plate 2 mm in thickness and the copper plate 4 mm in thickness were brazed and soldered by silver brazing to form a cooling mechanism.

Next, the AlN heaters, the holders, and the cooling mechanisms were screwed together to complete the heating and cooling modules. Heating and cooling modules were also created in which intermediate layers were inserted between the AlN heater and the holder, between the holder and the cooling mechanism, or between both, as shown in Table 3.

The thickness of the intermediate layers was 0.1 mm.

Semiconductor chips were mounted on these heating and cooling modules, and the temperature was increased from room temperature (25° C.) to 200° C. The characteristics of the semiconductor chips were evaluated, and then the chips were removed and cooled to room temperature. Fluorinert was used as the coolant in the cooling mechanisms, and the temperature was set to −60° C. The configurations of the heating and cooling modules, the time taken for the temperature to increase from room temperature to 200° C., and the time taken for the temperature to return to room temperature from 200° C. are shown in Table 3.

TABLE 3

| | | | | | Room | |
|---|---|---|---|---|---|---|
| | | | | | temperature | |
| | Intermediate | | | Intermediate | → 200° C. | |
| | layer | | | layer between | temperature | 200° C. → room |
| | between | | Applied | holder and | increase | temperature |
| | heater and | | voltage | cooling | time | cooling time |
| Heater | holder | Holder | (W) | mechanism | (minutes) | (minutes) |
| 1 | Alumina | A | 200 | Alumina | 2 | 2 |
| | added to Si | | | added to Si | | |
| | resin | | | resin | | |
| 1 | Si resin | A | 200 | Si resin | 2 | 2.2 |
| 1 | Si resin | A | 200 | none | 2 | 4 |
| 1 | none | A | 200 | Si resin | 1.5 | 4 |
| 1 | none | A | 200 | none | 1.5 | 6 |
| 1 | Si resin | B | 200 | Si resin | 2 | 2.4 |
| 1 | Si resin | C | 200 | Si resin | 2 | 2.4 |
| 1 | Si resin | D | 200 | Si resin | 2 | 2.4 |
| 1 | Si resin | E | 200 | Si resin | 2 | 6 |
| 1 | Si resin | F | 200 | Si resin | 2 | 2.4 |
| 1 | Si resin | G | 200 | Si resin | 2 | 5.5 |
| 1 | Si resin | H | 200 | Si resin | 2 | 3 |
| 1 | Polyimide | A | 200 | Polyimide | 2 | 2.5 |
| 2 | Polyimide | A | 400 | Polyimide | 2.1 | 2.6 |
| 3 | Polyimide | A | 600 | Polyimide | 2.2 | 2.7 |
| 4 | Polyimide | A | 600 | Polyimide | 2.4 | 3.0 |
| 5 | Polyimide | A | 200 | Polyimide | 2.4 | 5.2 |
| 6 | Polyimide | A | 200 | Polyimide | 2 | 2 |
| 7 | Polyimide | A | 200 | Polyimide | 1.8 | 1.8 |
| 8 | Polyimide | A | 1000 | Polyimide | 1.2 | 2.8 |

As is made clear in Table 3, the cooling time in particular can be reduced if intermediate layers are inserted between the AlN heater and the holder, and also between the holder and the cooling mechanism. None of the AlN heaters underwent any damage from the heat cycle, but the No. 7 AlN heater with a thickness of 0.25 mm was damaged when removed from the holder after all of the tests were completed.

The heating and cooling modules were heated to 300° C. The heating and cooling module using the No. 1 AlN heater reached this temperature in five minutes, and all of the other AlN heaters reached this temperature in 3 minutes or less.

### COMPARATIVE EXAMPLE

Instead of an aluminum nitride heater, a heater made of alumina (2 mm in thickness) was used to create a heating and cooling module having the same configuration as described above, and the alumina heater was damaged during heating when heating and cooling were conducted in the same manner as in the Embodiment.

### INDUSTRIAL APPLICABILITY

According to the present invention, it is possible to provide a heating and cooling module that is suitable for semiconductor chip testers having excellent temperature increase characteristics.

1. A heating and cooling module comprising
a ceramic heater for mounting and heating a treated object, a cooling mechanism for cooling the ceramic heater, and a holder between the ceramic heater and the cooling mechanism, wherein the ceramic heater is an aluminum nitride heater having one or more internally disposed heating element layers.

2. The heating and cooling module according to claim 1, wherein
an intermediate layer is provided between the ceramic heater and the holder.

3. The heating and cooling module according to claim 1,
wherein an intermediate layer is provided between the holder and the cooling mechanism.

4. The heating and cooling module according to claim 1,
wherein the ceramic heater has two or more heating element layers in the interior.

5. The heating and cooling module according to claim 1, wherein
the thermal conductivity of the holder is 100 W/mK or greater.

6. The heating and cooling module according to claim 1, wherein
the ceramic heater, the holder, and the cooling mechanism are mechanically fixed in place.
